(19) United States
(12) Patent Application Publication
(10) Pub. No.: US 2004/0149649 A1
(43) Pub. Date: Aug. 5, 2004

(54) Filter press type dewatering system, dewatering method, deaerator, check valve, and opening/closing valve

(76) Inventor: Seiji Uchiyama, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/473,393

(22) PCT Filed: Mar. 29, 2002
(86) PCT No.: PCT/JP02/03206

(30) Foreign Application Priority Data
Mar. 30, 2001 (JP) 2001-100734
Mar. 30, 2001 (JP) 2001-100735
Mar. 30, 2001 (JP) 2001-100736
Mar. 19, 2002 (JP) 2002-075819

(51) Int. Cl. C02F 1/00

(52) U.S. Cl. 210/600

(57) ABSTRACT

A filter press type dewatering system including a filter press machine, a hydraulically driven pressure-feed pump for compressing slurry introduced from a slurry supply source and driving the slurry into the filter press machine, a pressure control valve for increasing/reducing the flow rate of pressured oil supplied to the pressure-feed pump, a flow rate sensor for detecting the flow rate of filtered water discharged from the filter press machine, a pressure sensor for detecting dewatering pressure in the filter press machine, and control means of outputting a control signal to the pressure control valve in accordance with input signals from the flow rate sensor and the pressure sensor.

### TECHNICAL FIELD

The present invention relates to an improvement of a filter press type dewatering system.

### BACKGROUND ART

In order to promote volume reduction of inorganic type polluted sludge such as construction waste earth, etc. and organic type polluted sludge such as raw garbage, sewage sludge, etc., there has been recently used a filter press type dewatering system in which slurry type polluted sludge is driven into a filter press machine under high pressure by using a pressure-feed pump to perform solid-liquid separation of the slurry.

FIG. 18 shows an example of the construction of a general filter press type dewatering system 10, and it is equipped with a piston type pressure-feed pump 12, a filter press machine 14, a hydraulically-driving source 15 comprising a motor and a hydraulic pump, electromagnetically-controlled type first and second opening/closing valves 16 and 18, an air compressor 20, a slurry supply source 22 and a reservoir tank 24.

The slurry supply source 22 comprises a fluidizing tank having a raw garbage cutter and a suction pump. Water is filled in the fluidizing tank, and raw garbage introduced therein is kneaded with water while pulverized into particles having proper particle sizes by the cutter, thereby achieving slurry. The slurry thus achieved is fed into a slurry feed pipe 26 by the suction pump.

The slurry which reaches the inside of the cylinder 28 of the pressure-feed pump 12 through the slurry feed pipe 26 and the first opening/closing valve 16 is compressed by the pressurizing operation of a piston 30, and driven through the second opening/closing valve 18 into the filter press machine 14 under a predetermined pressure.

As shown in FIG. 19, many filter plates 32 are disposed in parallel in the filter press machine 14 so as to be freely opened/closed in the lateral direction. In a dewatering operation, the respective filter plates 32 are fixed in the closing direction under pressure by the press machine 34, and a filter chamber 36 is formed between the respective filter plates 32, 32.

A slurry introducing hole 38 is formed at the center portion of each filter plate 32 so as to penetrate through the filter plate 32. Filtered water grooves 40 are incised on both the right and left surfaces of each filter plate, and the surfaces of the grooves are covered by filter fabric 42.

The slurry 44 driven by the pressure-feed pump 12 passes through the slurry introducing hole 38 into the filter press machine 14, and spreads into each filter chamber 36 formed between the respective filter plates 32. The slurry is pressed against the surface of the filter fabric 42 to filtrate water, and solid components are separated from the water.

The water filtrated through the filter fabric 42 is passed through the filtered water grooves 40, guided to water discharge ports 46 equipped at the lower side of each filter plate 32, and then discharged to the outside through a water collecting pipe 48.

The filtered water reaches the reservoir tank 24 through a drain pipe 50, and a part of the water is returned to the fluidizing tank by a pump 52, and the residual water is subjected to a drainage treatment.

When one slurry driving operation using the pressure-feed pump 12 is completed, the second opening/closing valve 18 is closed and also the piston 30 is downwardly moved. At the same time, the first opening/closing valve 16 is opened and new slurry 44 is filled in the cylinder 28.

When the driving operation of the slurry 44 by the pressure-feed pump 12 is continued for a predetermined time, water is dropped out from each filter chamber 36 of the filter press machine 14 and solid dewatered cake 54 is filled in each filter chamber 36.

When reaching this stage, the electromagnetic opening/closing valve 25 is opened, and also high-pressure air is supplied from the air compressor 20 to the slurry introducing holes 38 of the filter plates 32 in the opposite direction. Therefore, the slurry clogging in the introducing holes 38 is returned through a feedback path 27 to the slurry supply source 22 and then filter plates 32 are opened in the right-and-left direction. As a result, the dewatered cake 54 accumulated between the respective filter plates 32, 32 exfoliates and falls down due to its dead weight, and is guided through a discharge hopper 56 onto a belt conveyor 58.

By using the filter press type dewatering system 10 as described above and increasing the final dewatering pressure in the filter pressure machine 14 to 3.5 to 4.0 Mpa or more with the pressure-feed pump 12, a high dewatering effect can be also achieved for organic type slurry which has been hitherto difficult to be effectively dewatered.

For example, even when dewatering is applied to slurry containing raw garbage, dewatered cake 54 having a water content percentage of 50% or less is achieved. Therefore, this system is expected to greatly contribute to the volume-reduction of waste materials.

However, the conventional filter press type dewatering system 10 has a problem that it takes a relatively long time to achieve a sufficient dewatering effect.

FIG. 20 is a graph showing the relationship between the dewatering pressure and the discharged water amount in the filter press machine 14. As shown in FIG. 20, the discharged water amount rises sharply upon driving slurry into the filter press machine 14, and it arrives at the peak after about mere ten minutes elapses from the dewatering start time. Thereafter, the discharged water amount is reduced irrespective of increase in pressure, and thus a compression treatment is required to be carried out for a long time in order to achieve a required discharged water amount.

It is estimated as one cause that cake formed at the compression initial stage is tightly solidified and serves as resistance to disturb subsequent dewatering. That is, just after the compression is started, the cake layer 54 is thin and thus has low resistance, so that a large amount of filtered water 62 is filtered out through the filter fabric 42 and discharged as shown in (a) of FIG. 21. On the other hand, the cake layer 54 is immediately thick, and tightly solidified under pressure as shown in (b) of FIG. 21. As a result, even when high pressure is applied by the pressure-feed pump 12, it is difficult for water to reach the filter fabric 42, and thus the discharged water amount is reduced. Therefore, the long-time treatment is needed to achieve a required dewatering amount.

As one countermeasure to solve this problem, it is considered that the distance between the filter plates 32, 32 in the dewatering operation is reduced. In this case, the cake thickness in individual filter chamber 36 is thin, and thus the resistance can be reduced to a small level.

In this case, however, in order to achieve required treatment capability, the number of filter plates 32 must be increased, which directly causes a problem that the filter press machine 14 is increased in size and the cost rises up. From the viewpoint of miniaturization of the equipment and reduction in cost, it is necessary that the distance between the filter plates 32, 32 is set to be large to some degree and also the number of filter plates 32 is reduced.

Furthermore, as another countermeasure, dewatering auxiliary agent may be added to the slurry 44 to form water paths in the cake layer 54. In this case, water can easily pass through the water paths and reach the filter fabric 42 even when the cake layer 54 is formed to be thick, and thus the distance between the filter plates 32, 32 can be set to a relatively large value.

This method is effective to inorganic sludge to some extent, however, it has a problem that it is not applicable to organic sludge. That is, in the case of the organic sludge, it is formed of protein, carbonhydrate, fat and oil, fiber and inorganic material, and physically forms hydrophilic colloids. In order to destroy hydrophilic colloids and cell membranes of bacteria, dewatering pressure of 3.5 Mpa or more is needed. However, the water paths generated by the dewatering auxiliary agent are crashed flatly under such high pressure.

Accordingly, a first object of the present invention is to provide a technique that can shorten a dewatering time by enhancing a dewatering efficiency while the thickness of dewatered cake formed between filter plates is set to a relatively large value.

Furthermore, although describing organic type sludge in a word, the organic type sludge contain various kinds of components in accordance with the causative agent generating the sludge, the treatment method, the season, etc., and thus in some cases a sufficient dewatering effect cannot be achieved particularly for sludge having a high percentage of bacteria content by only the filtering treatment of the filter press machine.

Accordingly, a second object of the present invention is to provide a technique of enabling a high-efficient dewatering treatment using a filter press machine even when a large amount of bacteria is contained in slurry organic type sludge.

Next, in order to effectively destroy hydrophilic colloids and cell membranes in organic type slurry, it is desirable that surface water and pore water are removed as much as possible at a stage before the sludge is fed to the pressure-feed pump 12.

However, when the amount of water in slurry is reduced, fluidity of slurry is lost, and thus slurry nodules are liable to occur, so that a large amount of air is contaminated among the slurry nodules.

If many air pools 45 exist in the cylinder 28 of the pressure-feed pump 12 or in the slurry feed pipe 26b communicating with the filter press machine 14, an inverse pumping phenomenon would be induced by the air pools 45 even when the slurry 44 is compressed by the piston 30, so that an extruding action is absorbed. As a result, the slurry 44 which might be originally driven into the filter press machine 14 under high pressure is trapped between the pressure-feed pump 12 and the filter press machine 14, and thus a desired dewatering effect cannot be achieved.

Accordingly, a third object of the present invention is to provide a technique of enabling air in slurry to be effectively removed when pressure is applied by a pressure-feed pump.

A pair of opening/closing valves are required to be equipped before and behind the pressure-feed pump 12 as described above. That is, the first opening/closing valve 16 equipped at the pre-stage of the pressure-feed pump 12 functions so that it is opened when the piston 30 moves backward, thereby filling slurry into the cylinder 28, and also it is closed when the piston 30 moves forwardly, thereby preventing backflow of the slurry. On the other hand, the second opening/closing valve 18 equipped at the post-stage of the pressure-feed pump 12 functions so that it is closed when the piston 30 moves backward, thereby preventing backflow of the slurry, and also it is opened when the piston 30 moved forwardly, thereby feeding the slurry to the filter press machine 14 side.

When such a function is required in a fluid control field for hydraulic pressure or the like, a ball type check valve 61 shown in FIG. 23 is generally used.

The ball type check valve 61 is designed so that a ball (steel ball) 63, a seat portion 64 and a spring 65 are mounted in a valve case 62. A flow-in port 66 is normally closed by the ball 63 urged by the spring 65. The back surface 64a of the seat portion 64 is located so as to face a discharge port 68, and thus it is designed so as to suffer pressure from the OUT side.

When IN-side pressure larger than “the urging force of the spring 65+the pressure at the OUT side” is applied to the flow-in port 66, the ball 63 is backward moved to open the flow-in port 66, and thus fluid gets into the inside. The fluid is discharged through a flow path 67 in the case 62 and then discharged from the discharge port 68.

In the case of the ball type check valve 61, not only the structure thereof is remarkably simple, but also it is naturally opened when the pressure at the IN side is larger than the pressure “the urging force of the spring 65+the pressure at the OUT side”. Therefore, no special control means is necessary.

However, when a check valve having such a structure is used in the filter press type dewatering system, slurry material containing solid components is passed through the spring 65, so that the slurry is firmly fixed to the spring 65 and disturbs the operation of the spring.

Therefore, in the slurry dewatering field, an electromagnetic opening/closing valve whose opening/closing operation can be controlled on the basis of an electrical signal is equipped at each of the front and rear sides of the pressure-feed pump 12.

In this case, no spring is needed to control the opening/closing operation, and there occurs no such a problem that slurry adheres to the spring and induces operation failure.

When the slurry in the filter press machine 14 is returned to the supply source 22, it can be returned to the supply source 22 through the pressure-feed pump 12 by opening both the electromagnetic opening/closing valves simultaneously, and thus the feedback path 27 and the electromagnetic opening/closing valve 25 can be omitted in some cases.

However, as the dewatering treatment in the filter press machine 14 progresses and the pressure at the filter press machine 14 side is increased, it becomes difficult to control the timing of the electromagnetic opening/closing valve. At this time, if the electromagnetic opening/closing valve at the filter press machine 14 side is opened by mistake when the piston 30 of the pressure-feed pump 12 gets into the return step, the slurry backflow phenomenon occurs, and thus a great impact sound occurs, so that there is a risk that the pressure-feed pump 12 or the pipe system may be damaged.

Accordingly, a fourth object of the present invention is to provide a check valve and an opening/closing valve in which operation failure due to attachment of slurry thereto can be prevented.

### SUMMARY OF THE INVENTION

In order to attain the first object, a first filter press type dewatering system according to the present invention is characterized by comprising: a filter press machine; a hydraulically-driven pressure-feed pump for compressing slurry introduced from a slurry supply source and driving the slurry thus compressed into the filter press machine; a pressure control valve for increasing/reducing the flow rate of pressured oil supplied to the pressure-feed pump; a flow rate sensor for detecting the flow rate of filtered water discharged from the filter press machine; a pressure sensor for detecting dewatering pressure in the filter press machine; and control means for outputting a control signal to the pressure control valve in accordance with input signals from the flow rate sensor and the pressure sensor.

A control method for the filter press type dewatering system according to the present invention is characterized in that when the flow rate of filtered water per unit time which is detected by the flow rate sensor is larger than a predetermined flow rate, the flow rate of pressured oil supplied to the pressure-feed pump is reduced to lower the dewatering pressure in the filter press machine, and when the flow rate of filtered water per unit time which is detected by the flow rate sensor is lower than a predetermined flow rate, the flow rate of pressured oil supplied to the pressure-feed pump is increased to increase the dewatering pressure in the filter press machine, whereby the degree of progress of the dewatering in the filter press machine is adjusted.

As described above, when the flow rate of the filtered water discharged from the filter press machine is out of a predetermined pattern, the flow rate of the pressured oil supplied to the pressure-feed pump is increased or reduced to adjust the applied pressure, whereby the dewatering pressure in the filter press machine can be adjusted, and further the progress degree of dewatering can be controlled.

Therefore, the applied pressure of the pressure-feed pump can be suppressed so that a cake layer is prevented from being tightly solidified at an initial stage of dewatering, and a relatively high dewatering efficiency can be kept for a long time. Accordingly, the time needed to achieve a fixed amount of filtered water can be shortened.

In order to attain the second object, a second filter press type dewatering system according to the present invention is characterized by comprising: a filter press machine; a pressure-feed pump for compressing slurry and driving the slurry thus compressed into the filter press machine; and a pre-treatment device disposed at a pre-stage of the pressure-feed pump, wherein the pre-treatment device has a slurry feed path for feeding the slurry from a slurry supply source side to the pressure-feed pump side, and a microwave oscillator for irradiating microwave to the slurry on the slurry feed path.

Generally, the microwave heating has the following features.

(1) High Speed Heating

Since microwave instantaneously infiltrates into an object to be heated and is converted to heat, it needs no pre-heating time and no time for thermal conduction.

(2) High Heat Efficiency

Since an object to be heated becomes a heating body, there does not occur any loss due to heating of surrounding air and facilities.

(3) Easiness in Handling

Instantaneous start/stop switching and temperature control based on output adjustment can be easily performed.

(4) Uniformity of Heating

Since the respective parts of an object to be heated are heated at the same time, even an object having completed shape can be relatively uniformly heated.

Accordingly, by irradiating microwave to the slurry being fed in the slurry feed path, bacteria cell membranes and hydrophilic colloids contained in the slurry can be sufficiently heated/destroyed in short time.

As described above, the cell membranes and the hydrophilic colloids in the slurry are heated/destroyed in advance by irradiation of microwave, whereby the effective dewatering treatment can be performed in the filter press machine.

The irradiation of microwave is strictly for the purpose of expanding internally-contained water to destroy the cell membranes and the hydrophilic colloids, and thus it does not intend to dry the overall slurry. Therefore, the increase in running cost can be suppressed to the minimum.

The pre-treatment device may comprise a cylinder formed of microwave-transmissible material, a screw feeder disposed in the cylinder, a motor for rotating the screw feeder, an outer shell portion formed of microwave reflecting material which air-tightly covers the outer periphery of the cylinder, and a microwave oscillator disposed in the outer shell portion. In this case, the cylinder and the screw feeder correspond to the “slurry feed path”.

The microwave output from the microwave oscillator is reflected from the internal surface of the outer shell portion, and irradiated to the slurry while travelling in the cylinder.

A slurry dewatering method according to the present invention is characterized by comprising: a step of irradiating microwave to slurry fed from a slurry supply source and heating/destroying cell membranes or hydrophilic colloids contained in the slurry; a step of compressing the slurry and driving the slurry into a filter press machine; and a step of executing solid-liquid separation of the slurry by filter fabric in the filter press machine.

In order to attain the third object, a degasifier interposed between a pressure-feed pump and a filter press machine according to the present invention is characterized by comprising: an introducing port for taking slurry supplied from the pressure-feed pump; a bore-enlarged portion that is enlarged in bore from the pressure-feed pump side to the filter press machine side; an air discharging portion having a discharged air guiding pipe; a bore-reduced portion that is reduced in bore from the pressure-feed pump side to the filter press machine side; and a discharging port for feeding out the slurry to the filter press machine, wherein an exhaust pipe is connected to at least one end of the discharge air guiding pipe and a vent hole is formed in the surface at the bore-reduced portion side so that air flowing in the vent hole is discharged through the exhaust pipe to the outside. The introducing port, the bore-enlarged portion, the air discharging portion, the bore-reduced portion and the discharging port are kept to intercommunicate with one another.

The slurry which is swiftly supplied from the pressure-feed pump to the introducing port is reduced in flow velocity at the bore-enlarged portion at which the bore (sectional area) of the flow path is sharply enlarged. As a result, the internal pressure of the slurry is reduced, and the air contained in the slurry is expanded and liberated from the slurry.

Force acts on this air at the bore-reduced portion where the flow path is narrowed again, so that the air is pushed backward. Therefore, the air is discharged from the vent hole of the discharged air guiding pipe through the exhaust pipe to the outside.

It is desirable that the air discharging portion is freely detachably interposed between the bore-enlarged portion and the bore-reduced portion.

As a result, even when solid materials clog at the vent hole, the air discharging portion can be easily detached and cleaned, or exchanged by a new one.

By using as the air discharging portion a first discharging unit and a second discharging unit each of which has a discharged air guiding pipe, and slidably interposing these discharging units between the bore-enlarged portion and the bore-reduced portion, the discharging unit interposed between the bore-enlarged portion and the bore-reduced portion and the discharging unit exposed to the outside may be exchanged by each other.

When the discharged air guiding pipe of one unit is clogged, the other unit is loaded in the device, and the discharged air guiding pipe of the unit discharged at the outside is cleaned, thereby enhancing the maintenance performance.

Porous ceramic filter or hollow fabric filter may be mounted in the air discharging guide pipe of the air discharging portion.

As a result, solid materials can be effectively prevented from invading into the air guiding pipe, and also the air discharged to the outside can be purified.

The discharged air guiding pipe of the air discharging portion is formed so that the cross-section thereof is substantially wedge-shaped, and it is positioned so that the cusp thereof faces the pressure-feed pump side and the flat surface portion thereof faces the filter press machine side. The vent hole is formed in the flat surface portion.

As described above, by using the discharged air guiding pipe having a wedged shape in section and making the cusp portion thereof face the pressure-feed pump side, the resistance to the slurry passing therethrough can be reduced. Besides, by forming the vent hole in the flat surface portion having large air resistance, air can be efficiently guided to the vent hole.

It is desirable that an opening/closing valve is equipped in the air discharging pipe, and a pressure sensor for detecting the pressure at the filter press machine side is equipped, and also it is desirable to equip control means for closing the opening/closing valve when the pressure at the filter press machine side is increased to a predetermined value or more.

When the pressure at the filter press machine side is increased, the flow velocity of the slurry supplied from the pressure-feed pump is reduced, and the air expansion/liberation effect as described above is lost. At the same time, the slurry may flow back to the vent hole of the discharged air guiding pipe. Therefore, it is effective to equip a mechanism for automatically closing the opening/closing valve.

In order to attain the fourth object, a check valve according to the present invention is characterized by comprising: a case having a flow-in port and a discharge port; a valve plug accommodating portion that is disposed in the case and has a first open portion confronting the flow-in port and a second open portion confronting the discharge port; a flow path through which the low-in port and the discharge port intercommunicate with each other; a cap-shaped valve plug that is freely slidably mounted in the first open portion and opens/closes the flow-in port; a cap-shaped pressure receiving member that is freely slidably mounted in the second open portion; a link portion for linking the valve plug and the pressure receiving member; a spring that is disposed in the valve plug accommodating portion and urges the valve plug in the closing direction; a first seal member that is interposed between the outer surface of the valve plug and the inner surface of the first open portion and prevents fluid from flowing into the valve plug accommodating portion; and a second seal member that is interposed between the outer surface of the pressure receiving member and the inner surface of the second open portion and prevents fluid from flowing into the valve plug accommodating portion.

In this case, the spring for urging the valve plug in the closing direction is disposed in the valve plug accommodating portion which is liquid-tightly sealed through the valve plug, the pressure receiving member and the seal member, and thus it is not brought into direct contact with slurry, so that there is no risk that operation failure occurs.

Furthermore, an opening/closing valve according to the present invention is characterized by comprising: a case having a flow-in port and a discharge port; a valve plug accommodating portion that is disposed in the case and has a first open recess portion confronting the flow-in port, a second open recess portion confronting the discharge port, a partition portion through which both the open recess portions are partitioned, and a through hole formed in the partition portion; a flow path through which the flow-in port and the discharge port intercommunicate with each other; a cap-shaped valve plug that is freely slidably mounted in the first open recess portion and opens/closes the flow-in port; a cap-shaped pressure receiving member mounted in the second open recess portion so as to be freely slidable; a link portion having a front end portion connected to the valve plug and a rear end portion connected to the pressure receiving member under the state that the link portion is freely slidably inserted in the through hole, thereby unifying the valve plug and the pressure receiving member; a spring that is disposed in the first open recess portion and urges the valve plug in the closing direction; a first seal member that is interposed between the outer surface of the valve plug and the inner surface of the first open recess portion and liquid-tightly seals the inside of the first open recess portion; a second seal member that is interposed between the outer surface of the pressure receiving member and the inner surface of the second recess portion and liquid-tightly seals the inside of the second open recess portion; a third seal member that is interposed between the outer surface of the link member and the inner surface of the through hole and prevents fluid from flowing between the first open recess portion and the second open recess portion; a first hydraulic port intercommunicating with the first open recess portion; and a second hydraulic port intercommunicating with the second open recess portion.

The opening/closing valve described above can perform the same function as the check valve normally because it has the same basic construction as the check valve. It is needless to say that the spring is mounted in the liquid-tightly sealed first open recess portion and thus there is no risk that operation failure occurs due to attachment of slurry.

Furthermore, by using an electromagnetic switching valve or the like, pressured oil is introduced to the second hydraulic port and at the same time the first hydraulic tank is connected to a tank, whereby the valve plug and the pressure receiving member can be forcedly opened irrespective of the pressure applied thereto. Therefore, even when the slurry clogging in the slurry introducing hole of each filter plate is returned from the filter press machine side to the slurry supply source side at the final stage of the dewatering processing, it is unnecessary to equip an electromagnetic opening/closing valve and a feedback path used for only bypassing purpose.

### BRIEF DESCRIPTION OF THE DRAWINGS

FIG. 1 is a conceptual diagram showing the overall construction of a first filter press type dewatering system according to the present invention.

FIG. 2 is a graph showing the relationship between the discharged water amount and the dewatering pressure in the dewatering system.

FIG. 3 is a graph showing a control pattern of the dewatering pattern in the dewatering system.

FIG. 4 is a graph showing a control pattern of the dewatering pressure in the dewatering system.

FIG. 5 is a graph showing a control pattern of the dewatering pressure in the dewatering system.

FIG. 6 is a conceptual diagram showing the overall construction of a second filter press type dewatering system according to the present invention.

FIG. 7 is a schematic diagram showing the structure of a pre-treatment device in the dewatering system.

FIG. 8 is a conceptual diagram showing the overall construction of a third filter press type dewatering system installed in a degasifier according to the present invention.

FIG. 9 is a vertically-sectional view showing the internal structure of the degasifier.

FIG. 10 is a horizontally-sectional view showing the internal structure of the degasifier.

FIG. 11 is a horizontally-sectional view showing another construction of the degasifier.

FIG. 12 is a sectional view taken along A-A of FIG. 11.

FIG. 13 is a sectional view showing the structure of the check valve (at the close time).

FIG. 14 is a sectional view showing the structure of the check valve (at the open time).

FIG. 15 is a sectional view taken along B-B of FIG. 13.

FIG. 16 is a sectional view showing the structure of an opening/closing valve according to the present invention.

FIG. 17 is a sectional view showing the structure of the opening/closing valve (at the open time).

FIG. 18 is a conceptual diagram showing the overall construction of a general filter press type dewatering system.

FIG. 19 is a schematic diagram showing a dewatering mechanism in the filter press type machine.

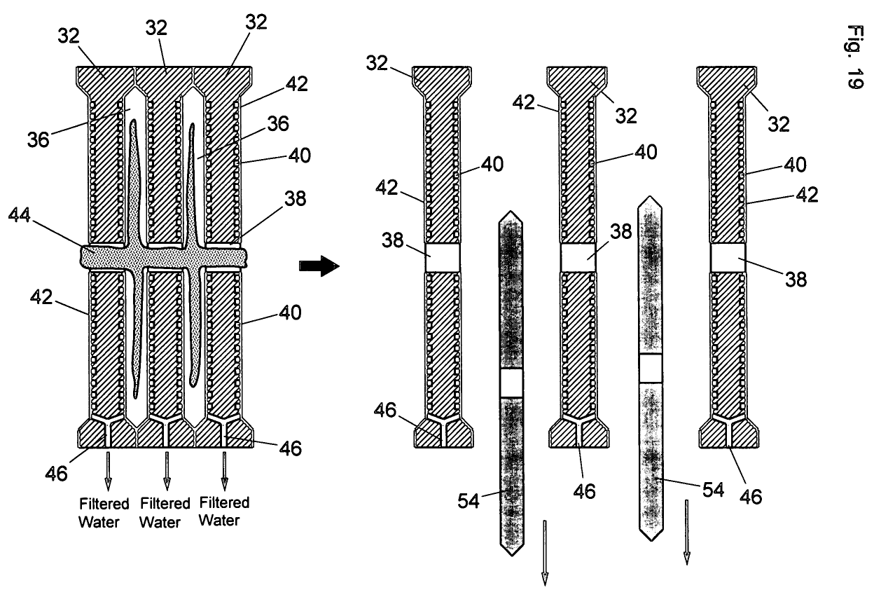

FIG. 20 is a graph showing the relationship between the discharged water amount and the dewatering pressure in a conventional dewatering system.

FIG. 21 is a schematic diagram showing a mechanism for generating dewatered cake in the filter press machine.

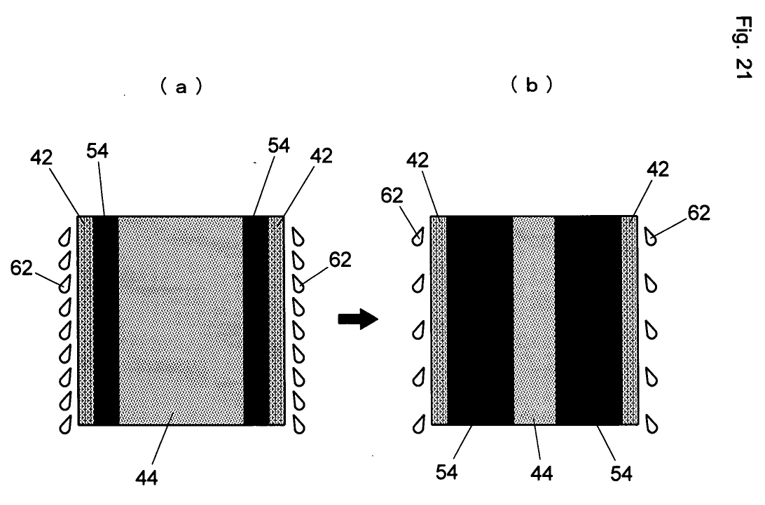

FIG. 22 is a partially sectional view showing the relationship between slurry and air pool in the conventional dewatering system.

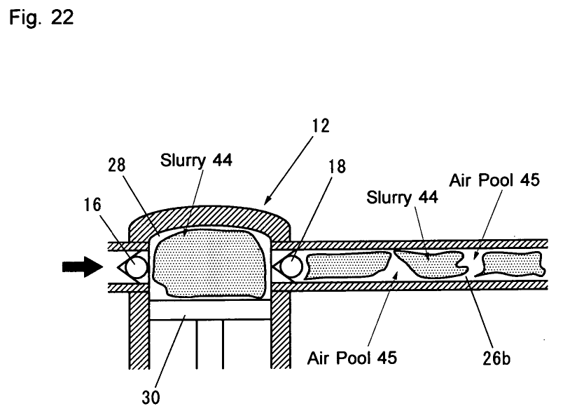

FIG. 23 is a sectional view showing the structure of a ball type check valve.

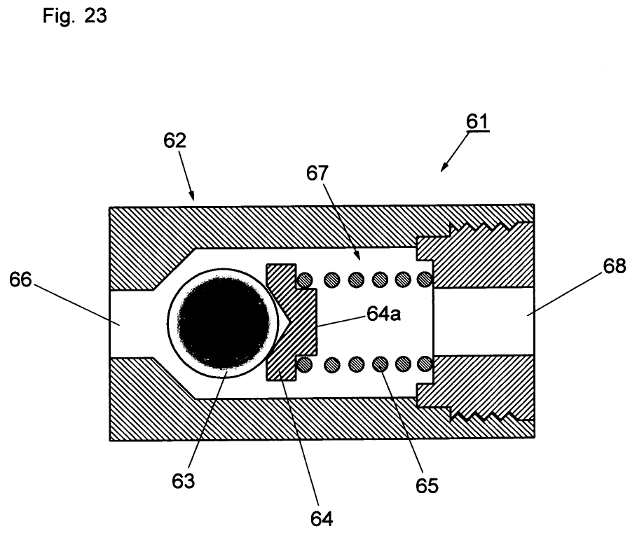

### BEST MODES FOR CARRYING OUT THE INVENTION

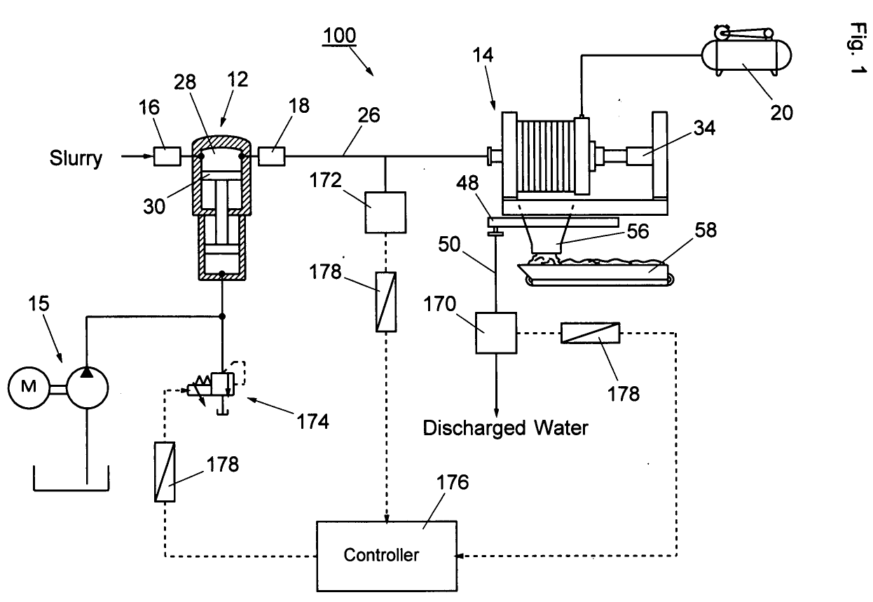

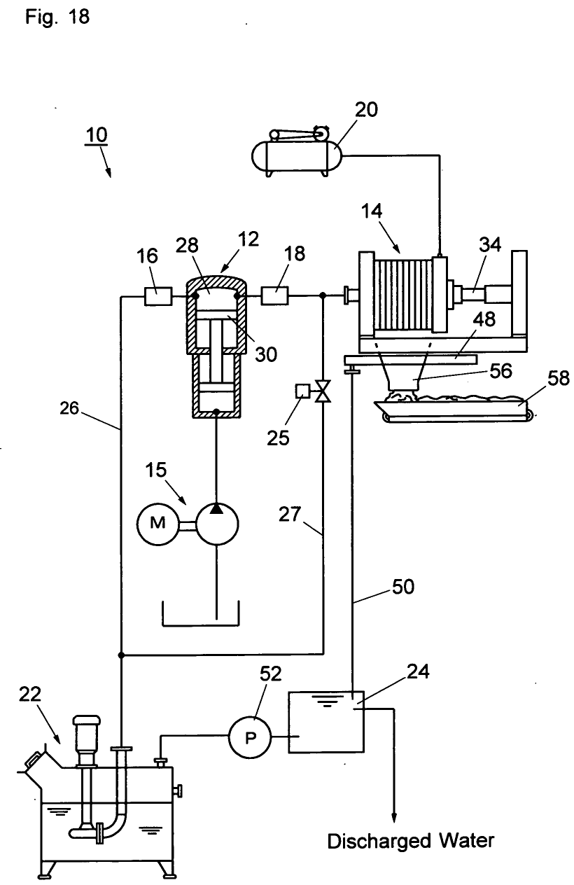

FIG. 1 is a conceptual diagram showing the overall construction of a first filter press type dewatering system 100 according to the present invention, and it is equipped with a piston type pressure-feed pump 12, a filter press machine 14, a first opening/closing valve 16 and a second opening/closing valve 18, and an air compressor 20 as in the case of the conventional dewatering system shown in FIG. 18. As omitted from the illustration, the slurry supply source 22 as described above is connected to a first electromagnetic valve 18 through a slurry feed pipe 26, and a drain pipe 50 is connected to the same reservoir tank 24 as described above.

The dewatering system 100 of this embodiment is further equipped with a flow rate sensor 170 equipped at some midpoint of the drain pipe 50, a pressure sensor 172 equipped at some midpoint of the slurry feed pipe 26 through which the second opening/closing valve 18 and the filter press machine 14 intercommunicate with each other, a pressure control valve 174 (relief valve) interposed between the pressure-feed pump 12 and the hydraulic driving source 15, and a controller 176.

The controller 176 has CPU such as a programmable controller, a personal computer or the like, and storage means having a control program stored therein, and it is electrically connected to the flow rate sensor 170, the pressure sensor 172 and the pressure control valve 174 through a signal amplifier 178.

The pressure control valve 174 can continuously adjust the flow rate of pressured oil supplied from the hydraulic driving source 15 to the pressure-feed pump 12 in accordance with a control signal from the controller 176, and specifically it is constructed by an electromagnetic proportional control valve.

A slurry dewatering process of the dewatering system 10 described above will be hereunder described.

First, slurry fed out from the slurry supply source is passed through the slurry feed pipe 26 to the first opening/closing valve 16, and then passed through the cylinder 28 of the pressure-feed pump 12 and the second opening/closing valve 18 into the filter press machine 14.

At the time point when the slurry substantially runs through each filter chamber of the filter press machine 14, the first opening/closing valve 16 is closed, and the pressured oil is supplied from the hydraulic driving source 15 to move the piston 30 of the pressure-feed pump 12 in the compression direction, so that the slurry in the cylinder 28 is driven into the filter press machine 14 side.

Subsequently, at the same time when the second opening/closing valve 18 is closed, the piston 30 is returned, and the first opening/closing valve 16 is opened, so that the slurry is filled in the cylinder 28.

By opening the second opening/closing valve 18 simultaneously with the closing of the first opening/closing valve 16 and driving the piston 30, the slurry is pressure-fed to the filter press machine 14.

By continuing the slurry driving operation of the pressure-feed pump 12, filtered water flows out from the water collecting pipe 48 of the filter press machine 14 to the drain pipe 50.

The flow rate of the filtered water passing through the drain pipe 50 is detected by the flow rate sensor 170, and input to the controller 176.

The driving pressure of the slurry directing from the pressure-feed pump 12 to the filter press machine 14 (=the dewatering pressure in the filter press machine 14) is also detected by the pressure sensor 172, and input to the controller 176.

In the controller 176, the input signal from each sensor is subjected to operation processing according to a predetermined program, and a control signal is output to the pressure control valve 174 to increase/reduce the applied pressure by the pressure-feed pump 12.

The pressure control valve 174 receiving the control signal adjusts the flow rate of the pressured oil supplied from the hydraulic driving source 15 to the pressure-feed pump 12, and controls the applied pressure of the pressure-feed pump 12.

As described above, by increasing/reducing the applied pressure of the pressure-feed pump 12 in accordance with the flow rate of the filtered water discharged from the filter press machine 14 and the dewatering pressure in the filter press machine 14, the dewatering efficiency in the filter press machine 14 can be optimized.

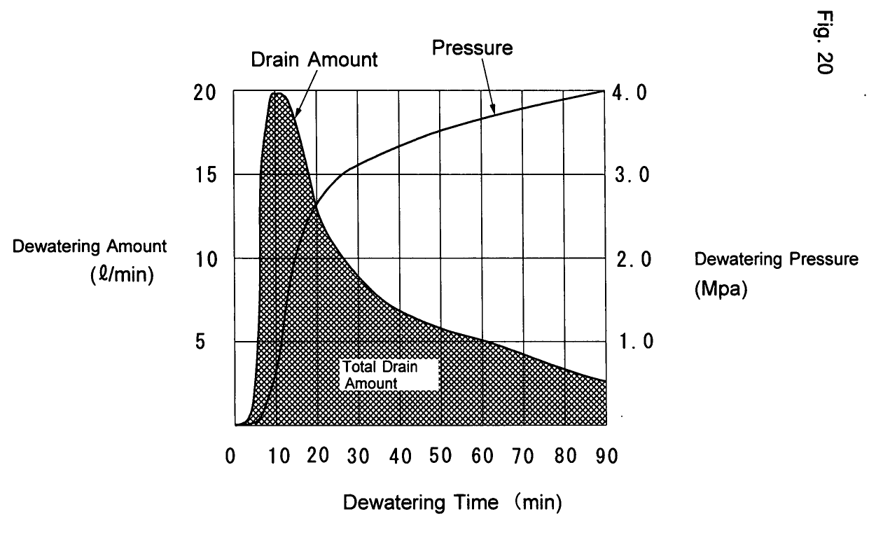

That is, in the case of the conventional dewatering system 10, the applied pressure of the pressure-feed pump 12 is not particularly controlled, and the dewatering pressure is naturally determined in accordance with the resistance in the filter press machine 14. Therefore, as shown in the graph of FIG. 20, the dewatering pressure is sharply increased at the initial stage of the dewatering treatment and thus a large amount of discharged water is achieved. However, the cake layer 54 is immediately tightly solidified and thus disturbs passage of water therethrough, so that the discharged water amount is drastically reduced.

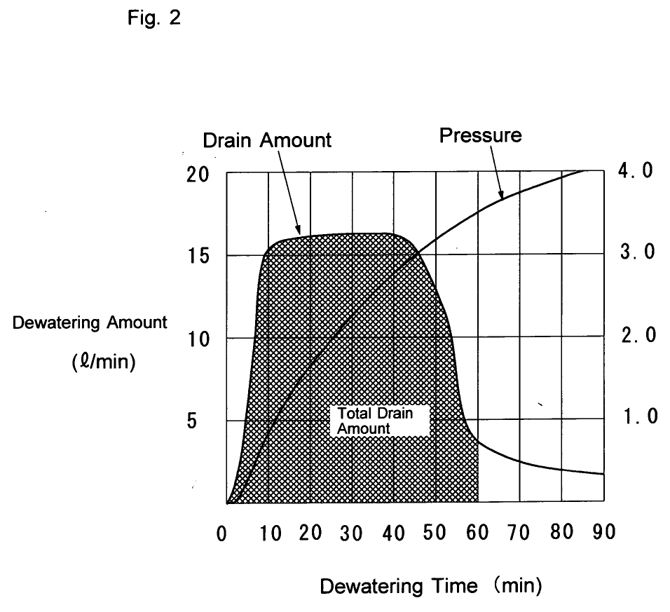

On the other hand, in the case of the first dewatering system 100 according to this invention, the solidification degree of the cake layer 54 is controlled by adjusting the increase of the dewatering pressure so that the dewatering pressure draws a relatively moderate curved line as shown in FIG. 2, whereby the discharged water amount is prevented from being drastically reduced.

Specifically, when the discharged water amount of filtered water per unit time is larger than a programmed set value, the controller 176 outputs the control signal to the pressure control valve 174 to reduce the amount of pressured oil to be supplied to the pressure-feed pump 12 by a required amount. At the same time, the controller 176 monitors the output from the pressure sensor 172, and checks whether the dewatering pressure in the filter press machine 14 is reduced as expected.

Conversely, if the discharged water amount of filtered water per unit time is smaller than the programmed set value, the controller 176 outputs the control signal to the pressure control valve 174 to increase the amount of pressured oil supplied to the pressure-feed pump 12 by a required amount. At the same time, the controller 176 monitors the output from the pressure sensor 172, and checks whether the dewatering pressure in the filter press machine 14 is increased as expected.

As a result, the peak of the discharged water amount can be kept for a relatively long time as shown in FIG. 2, and the same discharged water amount as the conventional system can be achieved in a shorter time.

The increasing pattern of the dewatering pressure is not constant, but it is naturally different in accordance with the characteristic of slurry to be dewatered. Particularly in the case of organic type polluted sludge, the difficulty level of dewatering and the formation progress degree of cake are greatly varied in accordance with the components of slurry. Therefore, in order to implement an ideal transition of the discharged water amount as shown in FIG. 2, the dewatering pressure is required to be minutely controlled every treatment target.

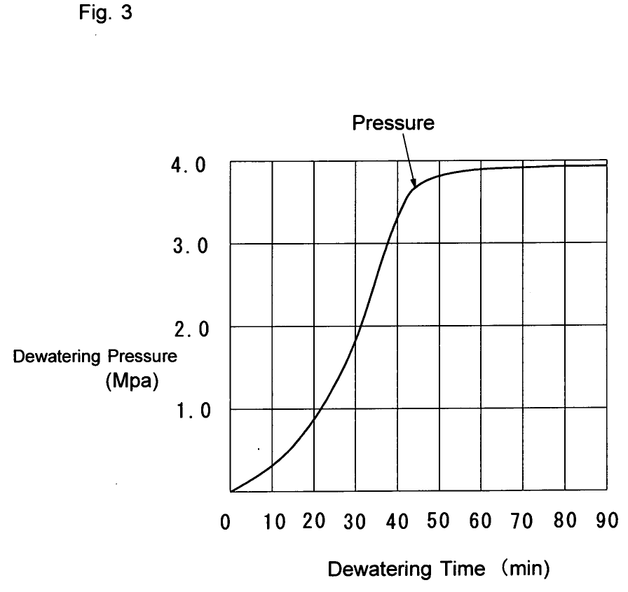

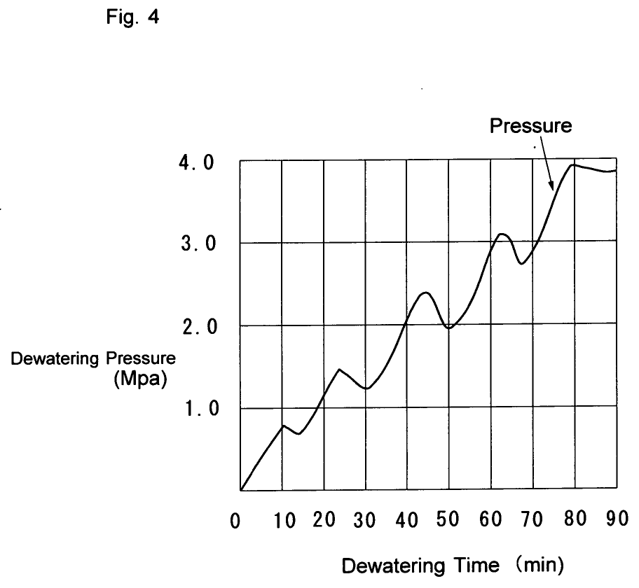

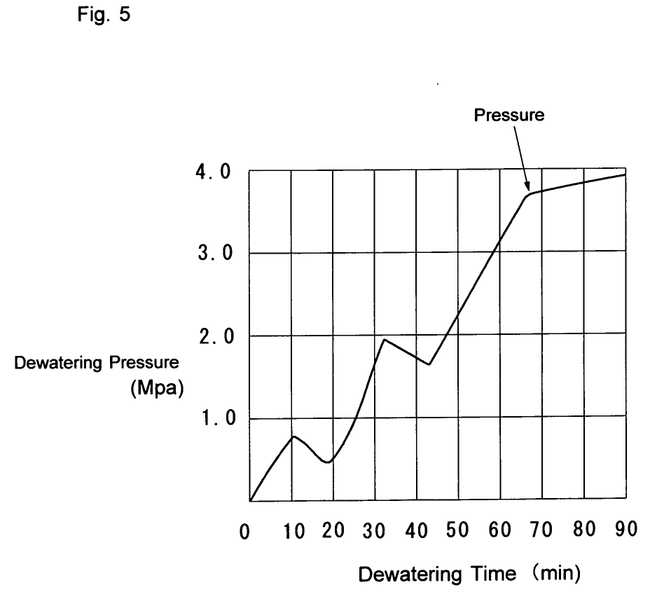

For example, the applied pressure of the pressure-feed pump 12 is controlled so that the pressure is gradually increased till the first half of the dewatering process and the pressure is kept at the time point when the pressure reaches the peak as shown in FIG. 3 or so that the pressure is increased as a whole while repeating increase and reduction of the pressure as shown in FIG. 4. FIG. 5 shows a compromise of both the patterns. In this case, the applied pressure of the pressure-feed pump 12 is controlled so that the increase/reduction of the pressure is repeated till the first half of the dewatering process, and then the pressure is smoothly increased till the peak pressure and kept to the peak pressure for some time.

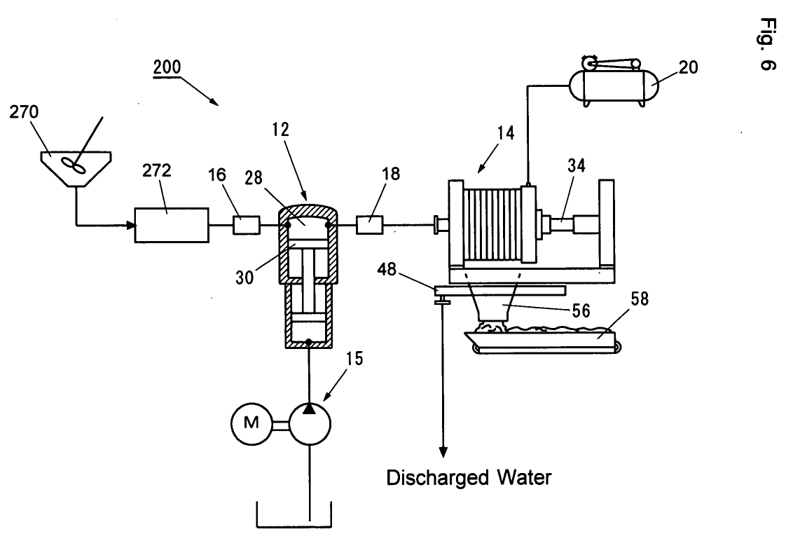

FIG. 6 is a conceptual diagram showing the overall construction of a second filter press type dewatering system 200 according to the present invention. Like the conventional dewatering system 10 shown in FIG. 18, this system is equipped with a piston type pressure-feed pump 12, a filter press machine 14, a hydraulic driving source 15 comprising a motor and a hydraulic pump, a first opening/closing valve 16 and a second opening/closing valve 18, and an air compressor 20.

A slurry introducing hopper 270 and a pre-treatment device 272 are disposed at a pre-stage of the first opening/closing valve 16.

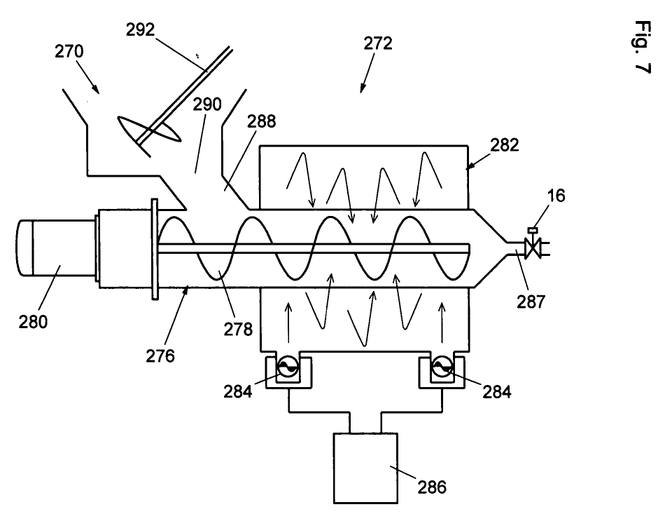

As shown in FIG. 7, the pre-treatment device 272 comprises a cylinder 276, a screw feeder 278 disposed in the cylinder 276, a decelerating motor 280 for rotationally driving the screw feeder 278, an outer shell portion 282 for covering the outer periphery of the cylinder 276 air-tightly, a pair of microwave oscillators 284 disposed in the outer shell portion 282, and a controller 286 for controlling ON/OFF and output of each microwave oscillator 284.

The cylinder 276 is formed of resin material having an excellent microwave-transmissible characteristic.

At least the inner surface of the outer shell portion 282 is formed of metal material having an excellent microwave reflection characteristic.

The fin pitch of the screw feeder 278 is set to 12.2 cm or more in consideration of the wavelength (12.2 cm) of microwave.

The front small-diameter portion 287 of the cylinder 276 intercommunicates with the first opening/closing valve 16.

A branch pipe 288 is equipped at the rear end portion of the cylinder 276, and the cylinder 276 intercommunicates with the open portion 290 of the introducing hopper 270 through the branch pipe 288.

The slurry dewatering process of the dewatering system 200 described above will be hereunder described.

First, when slurry organic type polluted sludge is introduced into the introducing hopper 270, the polluted sludge is supplied from the open portion 290 into the cylinder 276 while kneaded by rotation of a stirring screw 292.

In the cylinder 276, the polluted sludge is fed to the front end side by rotation of the screw feeder 278. At the time point when the slurry reaches the inside of the outer shell portion 282, it is provided with microwave output from the microwave oscillator 284 and heated.

As a result, water accumulated in bacterial cells and hydrophilic colloids is expanded to destroy the cell membranes and the hydrophilic colloids.

The slurry which has been subjected to the heat treatment by the microwave is supplied through the first opening/closing valve 16 into the pressure-feed pump 12.

Subsequently, in the same manner as described above, the slurry is passed through the cylinder 28 of the pressure-feed pump 12 and the second opening/closing valve 18, and filled into the filter press machine 14.

At the time point when the slurry substantially runs through each filter chamber of the filter press machine 14, the first opening/closing valve 16 is closed, and the piston 30 of the pressure-feed pump 12 is moved in the compression direction by applying the pressured oil from the hydraulic driving source 15 to the piston 30, thereby driving the slurry in the cylinder 28 into the filter press machine 14 side.

Subsequently, at the same time when the second opening/closing valve 18 is closed, the piston 30 is returned, and the first opening/closing valve 16 is opened to fill the slurry into the cylinder 28.

Here, at the same time when the first opening/closing valve 16 is closed, the second opening/closing valve 18 is opened, and the piston 30 is driven, whereby the slurry is pressure-fed into the filter press machine 14.

By continuously carrying out the slurry driving operation of the pressure-feed pump 12, water contained in the polluted sludge is separated from solid components through the filter fabric. The filtered water thus separated is discharged from the water collecting pipe 48 of the filter press machine 14 to the outside.

As described above, since the cell membranes and the hydrophilic colloids contained in the slurry are heated and destroyed in the pre-treatment device 272, the dewatering treatment can be extremely effectively performed in the filter press machine 14 even when a large amount of bacteria is contained in the polluted sludge.

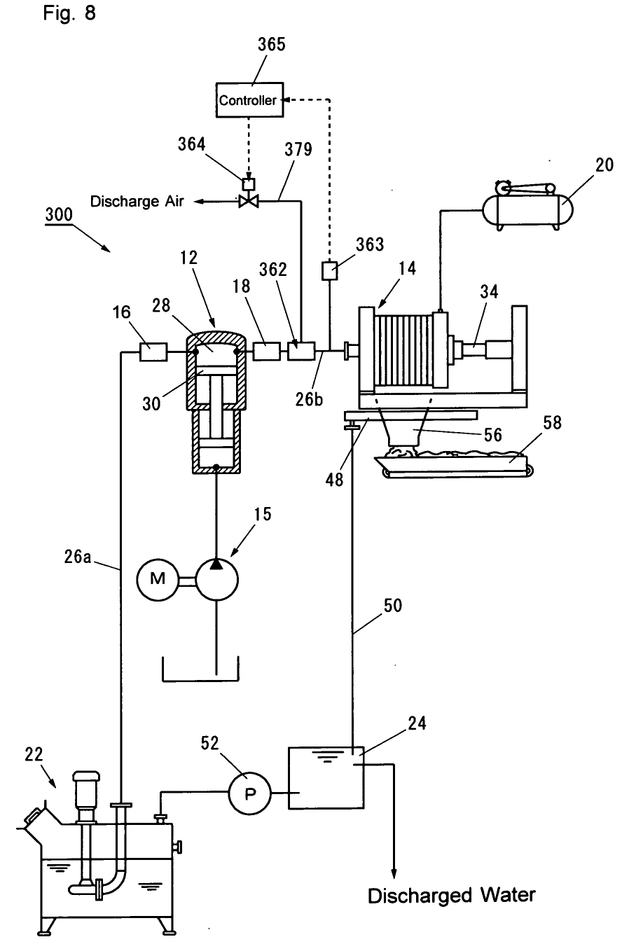

FIG. 8 is a conceptual diagram showing the overall construction of a third filter press type dewatering system according to the present invention. Like the conventional dewatering system 10 shown in FIG. 18, this system is equipped with a piston type pressure-feed pump 12, a filter press machine 14, a hydraulic driving source 15, a first opening/closing valve 16 and a second opening/closing valve 18, an air compressor 20, a slurry supply source 22 and a reservoir tank 24.

The third dewatering system 300 is further equipped with a degasifier 362 interposed between the second opening/closing valve 18 and the filter press machine 14, a pressure sensor 363 equipped at some midpoint of the slurry feed pipe 26b, an electromagnetic opening/closing valve 364 equipped in the exhaust system of the degasifier 362, and a controller 365 electrically connected to the pressure sensor 363 and the electromagnetic opening/closing valve 364.

The controller 365 has CPU such as a programmable controller, a personal computer or the like, and storage means in which a control program is stored.

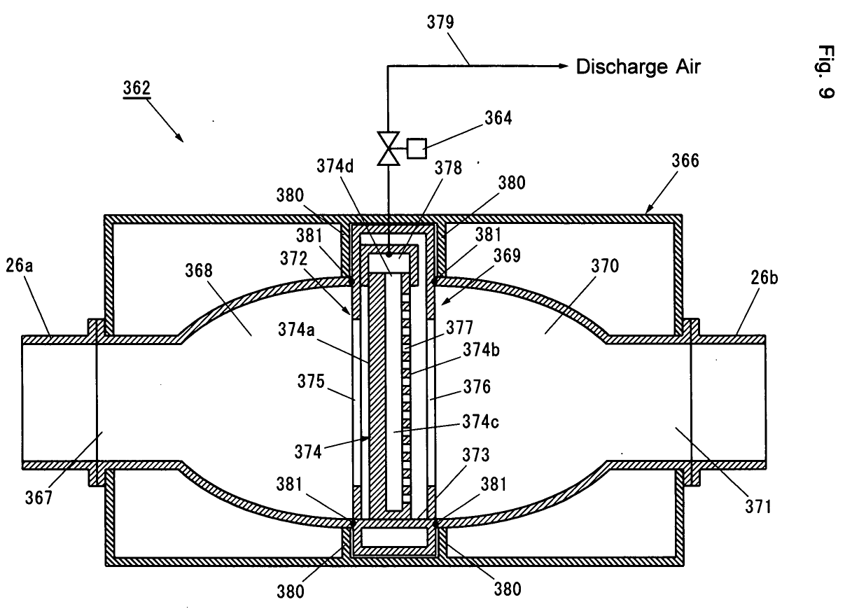

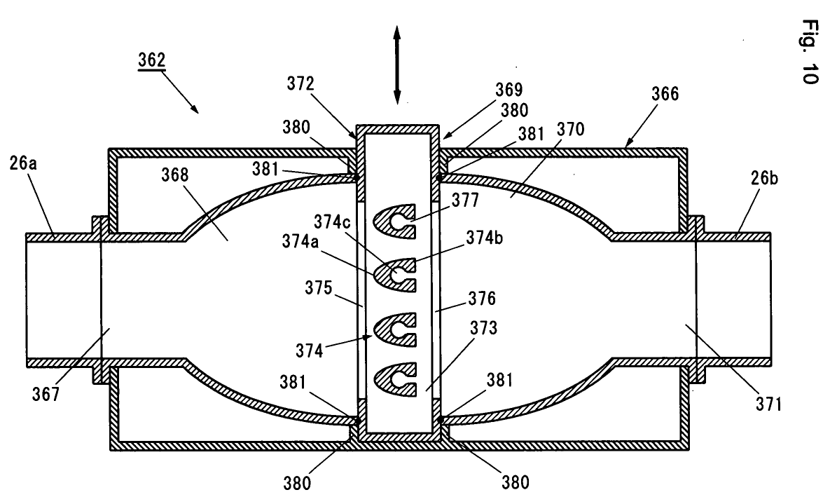

As shown in the longitudinally-sectional view of FIG. 9 and the cross-sectional view of FIG. 10, the degasifier 362 is equipped with a substantially rectangular parallelepiped housing 366, a slurry introducing port 367, a bore-enlarged portion 368 mounted in the housing 366, an air exhaust portion 369, a bore-reduced portion 370 and a slurry discharging port 371.

The introducing port 367 intercommunicates with the slurry feed pipe 26a at the pressure-feed pump 12 side, and has substantially the same diameter as the slurry feed pipe 26a.

The discharging port 371 intercommunicates with the slurry feed pipe 26b at the filter press machine 14 side, and has substantially the same diameter as the slurry feed pipe 26b.

The bore-enlarged portion 368 is formed integrally with the introducing port 367, and it is designed in such a funnel-shape that the bore is enlarged from the pressure-feed pump 12 side to the filter press machine 14 side.

The bore-reduced portion 370 is formed integrally with the discharging port 371, and it is designed in such a funnel-shape that the bore is reduced from the pressure-feed pump 12 side to the filter press machine 14 side.

The air exhaust portion 369 is interposed between the bore-enlarged portion 368 and the bore-reduced portion 370, and has a substantially rectangular frame member 372, and plural exhaust gas guiding pipes 374 erected from the bottom surface 373 of the frame member 372.

The frame member 372 has a first open portion 375 intercommunicating with the open portion of the bore-enlarged portion 368, and a second open portion 376 intercommunicating with the open portion of the bore-reduced portion 370, and the respective exhaust gas guiding pipes 374 are arranged between the first open portion 375 and the second open portion 376 so as to be spaced from one another at a predetermined interval.

As shown in FIG. 10, each exhaust gas guiding pipe 374 has a wedge-shaped section, and it is positioned so that the cusp portion 374a thereof faces the pressure-feed pump 12 side, and the flat surface portion 374b thereof faces the filter press machine 14 side.

Many vent holes 377 are formed in the flat surface portion 374b so as to be arranged in the direction from the upper side to the lower side at a predetermined interval, and each vent hole 377 intercommunicates with a cavity portion 374c penetrating through the center of the exhaust air guiding pipe 374.

An upper end open portion 374d of each exhaust air guiding pipe 374 intercommunicates with a common gas collecting box 378, and an exhaust pipe 379 intercommunicates with the gas collecting box 378.

The frame member 372 is mounted so as to be freely slidable along a guide portion 380 in the housing 366, and it can be easily exchanged by another air exhaust portion 369.

A proper seal member 381 is interposed between the surface of the frame member 72 and the end face of each of the bore-enlarged portion 368 and the bore-reduced portion 370, so that they are kept air-tight.

Next, the slurry dewatering process of the third dewatering system 300 will be hereunder described.

First, the slurry fed out from the slurry supply source 22 reaches the first opening/closing valve 16 through the slurry feed pipe 26, passes through the cylinder 28 of the pressure-feed pump 12, the second opening/closing valve 18 and the degasifier 362 and then is filled in the filter press machine 14.

At the time point when the slurry substantially runs through each filter chamber of the filter press machine 14, the piston 30 of the pressure-feed pump 12 is supplied with pressured oil from the hydraulic driving source 15 and moved in the compression direction, so that the slurry in the cylinder 28 is driven to the filter press machine 14 side.

Subsequently, at the same time when the piston 30 is returned, the second opening/closing valve 18 is closed, and the first opening/closing valve 16 is opened, so that the slurry is filled in the cylinder 28.

At this time, when the piston 30 is driven again, the second opening/closing valve 18 is opened simultaneously with closing of the first opening/closing valve 16, the slurry is pressure-fed to the filter press machine 14 side, and air in the slurry is effectively removed during the passage of the slurry through the degasifier 362.

By continuing the slurry driving operation of the pressure-feed pump 12 described above, filtered water flows out from the water collecting pipe 48 of the filter press machine 14 to the drain pipe 50.

Here, the air removing mechanism in the degasifier 362 will be described.

First, when the slurry is driven under high pressure by driving the pressure-feed pump 12, the slurry containing air pools are fed to the introducing port 367 of the degasifier 362 at a fixed flow rate or more.

Subsequently, when the slurry arrives at the bore-enlarged portion 368 at which the cross section is drastically enlarged more than the introducing port 367, the flow rate is drastically reduced, and the internal pressure is reduced. As a result, the air pools contained in the slurry are expanded and librated from the slurry.

Since the flow path is narrowed at the bore-reduced portion 370 again, the expanded air is forced to be pushed backward due to its reduction, and guided into the vent holes 377.

Air passed from the vent holes 377 through the cavity portions 374c ascends in the exhaust air guiding pipes 374, collected in the gas collecting box 378 and then discharged through the exhaust pipe 379 to the outside.

When the dewatering treatment progresses and the pressure at the filter press machine 14 side increases due to expansion of the cake layer, the flow rate of the slurry supplied to the bore-enlarged portion 368 is reduced to lower the expansion/liberation effect of the air pools, and also the probability that the slurry flows back into the vent holes 377 is increased, so that the electromagnetic opening/closing valve 364 is closed and the degasification treatment is stopped. Specifically, at the time point when the pressure input from the pressure sensor 363 is increased to a set value or more, a control signal is output from the controller 365 to the electromagnetic opening/closing valve 364 to automatically close the exhaust pipe 379.

As the degasifier 362 described above is continuously used, it is unavoidable that solid materials invade into the vent holes 377 and clogging occurs. In this case, the air exhaust portion 369 may be extracted from the housing 366 to be cleaned or exchanged by a new one. Alternatively, cleaning water is supplied from the exhaust pipe 379 to back-wash the inside of the exhaust guiding pipe 374 and discharge the solid materials from the vent holes 377.

Furthermore, by mounting porous ceramic filter or hollow fabric filter in the cavity portions 374c of the exhaust air guiding pipes 374, the clogging can be effectively prevented and also the air to be discharged to the outside can be cleaned.

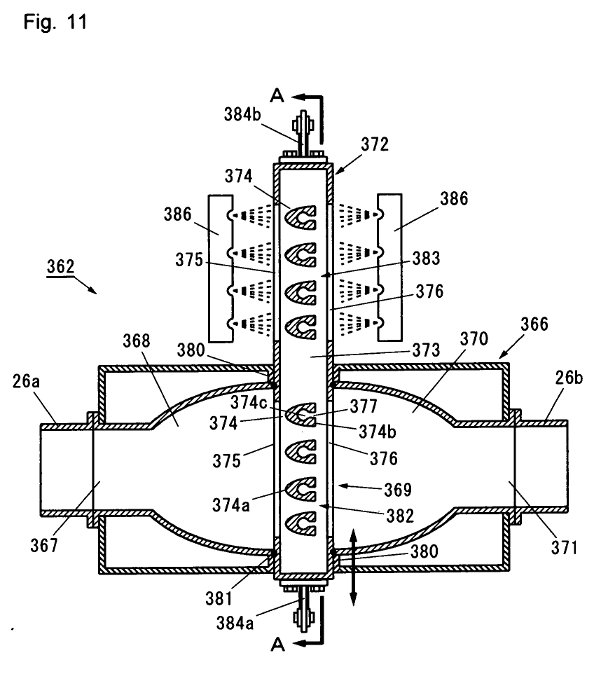

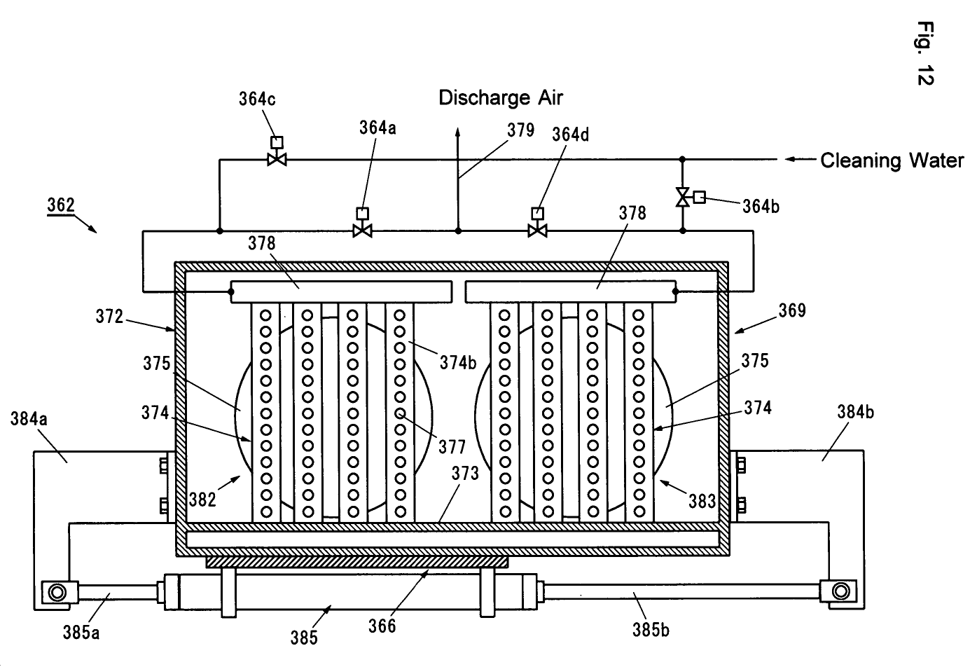

FIGS. 11 and 12 show another construction of the degasifier 362, and two sets of exhaust units are equipped in the frame member 372 of the air exhausted portion 369.

That is, in the frame member 372 are disposed a first exhaust unit 382 having four exhaust air guiding pipes 374, and a second exhaust unit 383 having four exhaust guiding pipes 374. The exhaust air guiding pipes 374 of the respective units intercommunicate with different gas collecting boxes 378.

Furthermore, link pieces 384a, 384b are connected to both the side surfaces of the frame member 372.

A hydraulically-driven cylinder 385 is mounted on the lower surface of the housing 366, and a pair of driving shafts 385a, 385b of the cylinder 385 are connected to the link pieces 384a, 384b, respectively.

Therefore, by driving the driving shafts 385a, 385b of the cylinder 385 in the right-and-left direction, the air exhaust portion 369 is slid along a guide portion 380 of the housing 366, and the exhaust unit to be set in the housing 366 can be switched.

As described above, the two sets of exhaust units are equipped to the air exhaust portion 369 so that the unit to be set in the housing 366 can be switched by the driving of the cylinder, so that the driving efficiency of the degasifier 362 and the maintenance performance can be enhanced.

That is, if the degasifying effect is lowered due to occurrence of clogging when one of the units is used to degas, the degasifying effect could be kept by immediately sliding the frame member 372 and exchanging it by the other unit.

With respect to the unit thus detached from the housing 366, the surfaces of the exhaust air guiding pipes 374 may be cleaned by shower 386 as shown in FIG. 11, or cleaning water may be introduced to the exhaust pipe 379 to back-wash the inside of each exhaust air guiding pipe 374 as shown in FIG. 12.

Four electromagnetic opening/closing valves are equipped in the exhaust pipe 379. When the first exhaust unit 382 is used for the degasifying treatment and at the same time the second exhaust unit 383 is back-washed, the first opening/closing valve 364a and the second opening/closing valve 364b are opened, and the third opening/closing valve 364c and the fourth opening/closing valve 364d are closed.

Conversely, when the second exhaust unit 383 is used for the degasifying treatment and at the same time the first exhaust unit 382 is back-washed, it is sufficient to open the third opening/closing valve 364c and the fourth opening/closing valve 364d are opened and close the first opening/closing valve 364a and the second opening/closing valve 364b.

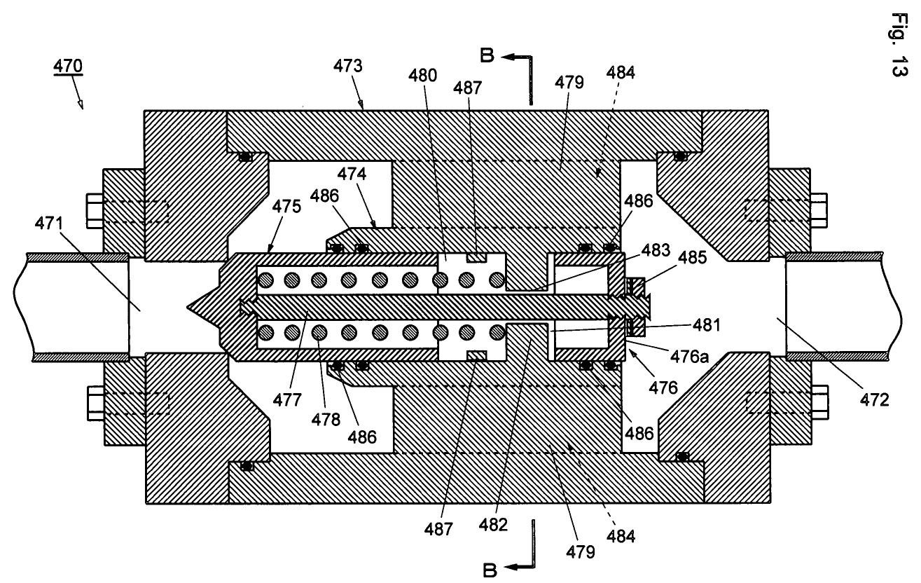

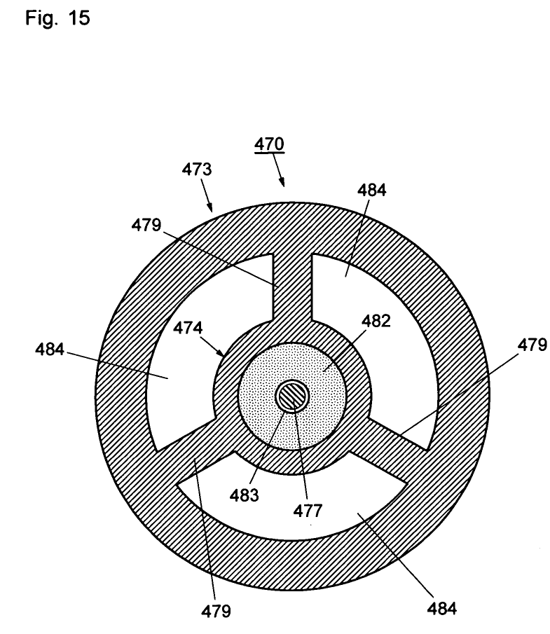

In the filter press type dewatering system 10 shown in FIG. 18, check valves 470 according to the present invention are equipped before and behind the pressure-feed pump 12 and function as a first opening/closing valve 16 and a second opening/closing valve 18, respectively. As shown in FIGS. 13 to 15, each check valve is equipped with a cylindrical valve case 473 having a flow-in port 471 and a discharging port 472 for slurry, a cylindrical valve plug accommodating portion 474, a cap-shaped (corn-shaped) valve plug 475 having a cuspidate tip portion, a cap-shaped pressure receiving member 476, a link rod 477 and a coil spring 478.

The valve plug accommodating portion 474 is supported in the neighborhood of the center of a case 473 by three support members 479 erected from the inner surface of the case 473, and it has a first open recess portion 480 confronting the flow-in port 471, a second open recess portion 481 confronting the discharge port 472, and a partition portion 482 through which both the open recess portions are partitioned. A through hole 483 penetrating through the first open recess portion 480 and the second open recess portion 481 is formed at the center portion of the partition portion 482.

A slurry flow path 484 is formed between the outer peripheral surface of the valve plug accommodating portion 474 and the inner peripheral surface of the valve case.

The valve plug 475 is freely slidably mounted in the first open recess portion 480. The pressure receiving member 476 is freely slidably mounted in the second open recess portion 481.

The spring 478 is inserted in the valve plug 475, and mounted in the first open recess portion 480 together with the valve plug 475. As a result, one end of the spring 478 is brought into contact with the inner surface of the valve plug 475, and also the other end thereof is brought into contact with the partition portion 482.

The link rod 477 is inserted in the through hole 483 of the partition portion 482, and the front end portion thereof is screw-fitted to the inner surface of the valve plug 475 while the link rod 477 is inserted in the spring 478. The rear end portion of the link rod 477 penetrates through the flat surface portion 476a of the pressure receiving member 476 and screw-fitted at the outside by a nut 485.

As a result, the valve plug 475 and the pressure receiving member 476 are unified into one body through the link rod 477, so that when one is slid, the other is slid in the same direction.

An O-ring 486 serving as a seal member is interposed between the inner peripheral surface of the first open recess portion 480 and the outer peripheral surface of the valve plug 475, and also an O-ring 486 is interposed between the inner peripheral surface of the second open recess portion 481 and the outer peripheral surface of the pressure receiving member 476.

As a result, the first open recess portion 480 is liquid-tightly sealed by the valve plug 475 ad the O-ring 486, and the second open recess portion 481 is also liquid-tightly sealed by the pressure receiving member 476 and the O-ring 486.

Accordingly, even when the sliding motion of the valve plug 475 and the pressure receiving member 476 is repeated, there is no risk that the slurry invades into the first open recess portion 480 or the second open recess portion 481.

The valve plug 475 is normally urged by the spring 478 so as to close the flow-in port 471. Pressure is applied from the discharge port 472 side to the flat surface portion 476a of the pressure receiving member 476.

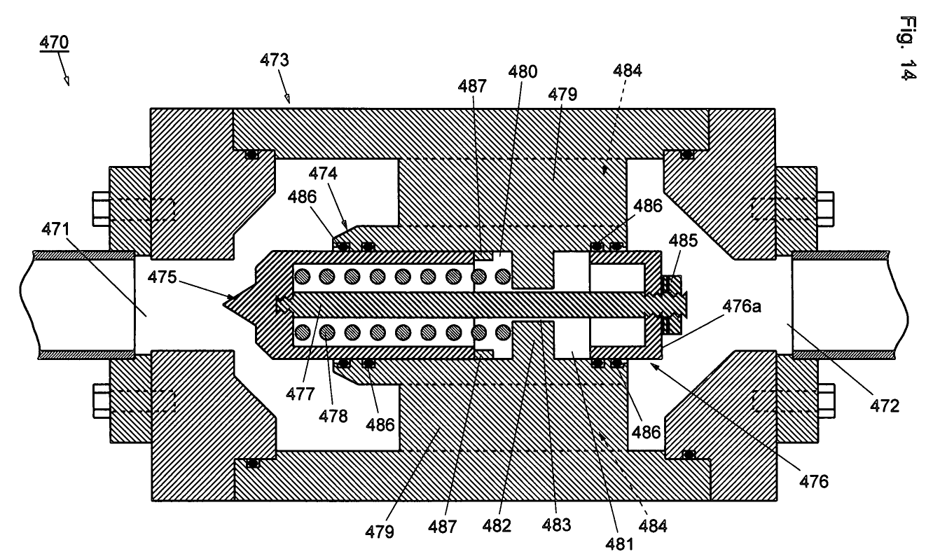

On the other hand, when pressure larger than “the urging force of the spring 478+the pressure at discharge port 472 side” is applied from the flow-in port 471 side, the valve plug 475 is backward moved as shown in FIG. 14, and the flow-in port 471 is opened.

A stopper 487 is equipped to the inner peripheral surface of the first open recess portion 480 so as to project from the inner peripheral surface, so that there is no case where the valve plug 475 is excessively backward moved and the whole of the pressure receiving member 476 is protruded from the second open recess portion 481.

Next, the slurry dewatering process of the filter press type dewatering system 10 in which the check valves 470 are installed as the first opening/closing valve and the second opening/closing valve will be described hereunder (the first opening/closing valve 16 and the second opening/closing valve 18 of FIG. 18 are read as a first check valve 470a and a second check valve 470b).

First, slurry transmitted from the slurry supply source 22 passes through the slurry feed pipe 26 and reaches the first check valve 470a to press the valve plug 475. As a result, the flow-in port 471 is opened, and the slurry flows in the first check valve 470a. The flow-in slurry is passed through the flow path 484 and fed from the discharge port 472 into the cylinder 28 of the pressure-feed pump 12.

Subsequently, the slurry presses the valve plug 475 of the second check valve 470b to open the flow-in port 471, and then is fed from the discharge port 472 to the filter press machine 14.

At the time point when the slurry substantially runs through each filter chamber 36 of the filter press machine 14, pressured oil is supplied from the hydraulically driving source 15, and the piston 30 of the pressure-feed pump 12 is moved in the compression direction.

At this time, pressure is applied from the piston 30 to the pressure-receiving member 476 of the first check valve 470a, and thus the flow-in port 471 thereof is closed. On the other hand, the pressure is applied from the piston 30 to the valve plug 475 of the second check valve 470b, and thus the flow-in port 471 thereof is opened. As a result, the slurry in the cylinder 28 is driven to the filter press machine 14 side.

Subsequently, when the piston 30 starts returning, negative pressure is applied to the pressure-receiving member 476 of the first check valve 470a and the valve plug 475 of the second the first check valve 475, so that the first check valve 470a is opened and the second check valve 470b is closed. As a result, new slurry is filled in the cylinder 28.

Here, when the piston 30 is driven again, in the same manner as described above, the first check valve 470a is closed and the second check valve 470b is opened at the same time, so that slurry is pressure-fed to the filter press machine 14 side.

By continuing the slurry driving operation of the pressure-feed pump 12, filtered water flows out from the water collecting pipe 48 of the filter press machine 14 to the drain pipe 50.

When the dewatering process reaches the final step, as described above, the electromagnetic opening/closing valve 25 is opened, and high-pressure air from the air compressor 20 is supplied into the filter press machine 14, so that slurry clogging in the slurry introducing hole 38 of the filter plate 32 is passed through the feedback path 27 and returned to the slurry supply source 22.

with respect to the check valve 470, the spring 478 is mounted in the first open recess portion 480, and thus it is not brought into contact with slurry, so that there is no risk that operation failure occurs due to attachment of slurry.

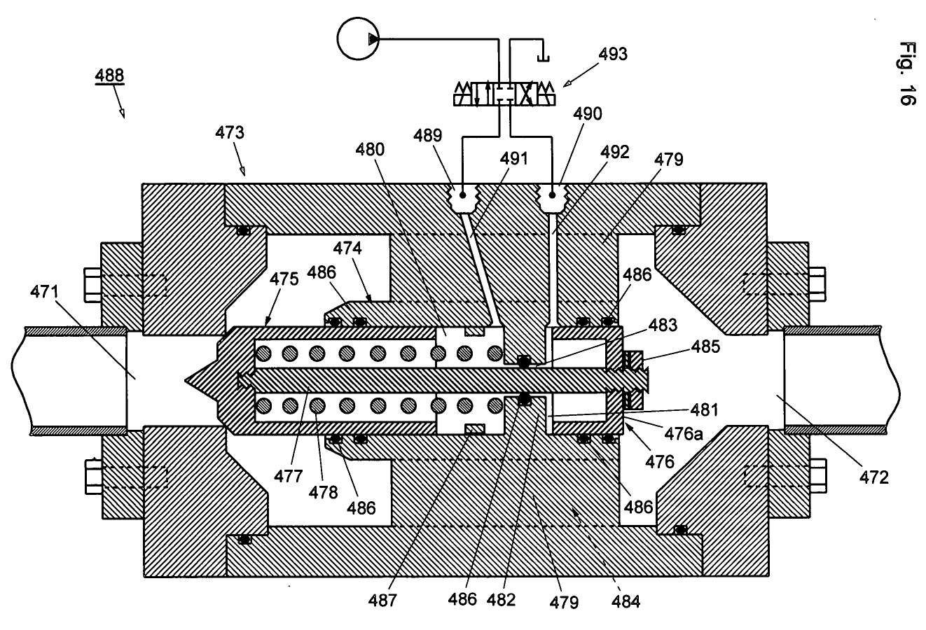

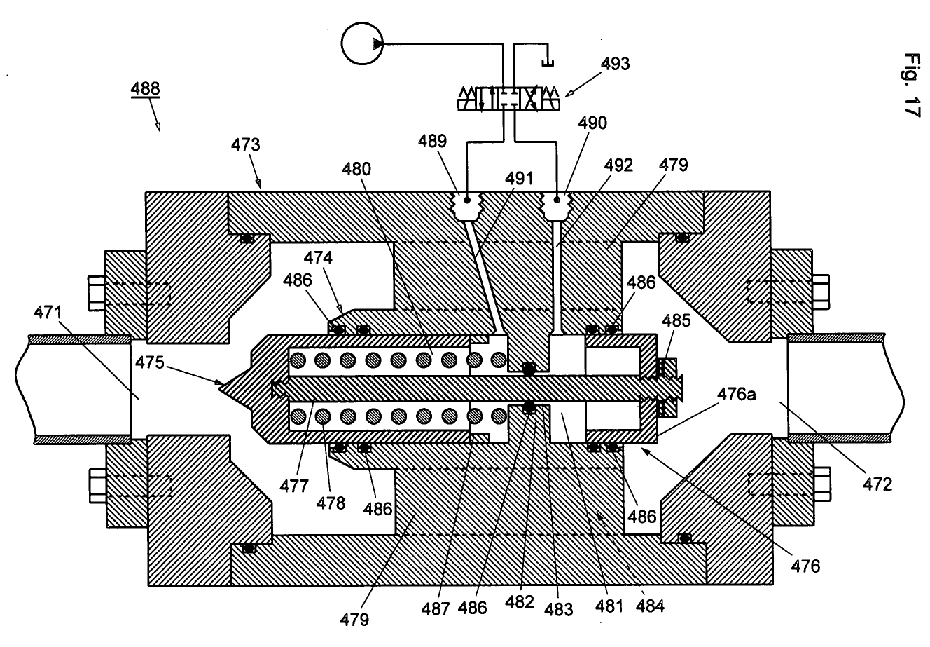

FIGS. 16 and 17 show an opening/closing valve 488 according to the present invention. Most of the construction of the opening/closing valve 488 is common to the check valve 470 as described above, and thus duplicative description is avoided by using the same reference numerals for the same members. In the following description, the different points will be mainly described hereunder.

First, an O-ring 486 is engagedly interposed between the inner peripheral surface of a through hole 483 formed in the partition portion 482 of the valve plug accommodating portion 474 and the outer peripheral surface of the link rod 477, so that liquid-tightness is kept between the first open recess portion 480 and the second open recess portion 481.

Secondly, a first hydraulic port 489 and a second hydraulic port 490 are equipped in the case 473. The first hydraulic port 489 intercommunicates with the first open recess portion 480 through a first oil path 491, and the second hydraulic port 490 intercommunicates with the second open recess portion 481 through a second oil path 492.

An electromagnetic switching valve 493 is connected to the first hydraulic port 489 and the second hydraulic port 490. As a result, by outputting a control signal to the electromagnetic switching valve 493 to switch the hydraulic pressure direction, the valve plug 475 and the pressure-receiving member 476 can be forcedly opened/closed irrespective of the magnitude of the pressure applied to the valve plug 475 and the pressure-receiving member 476.

For example, if pressured oil is supplied to the first hydraulic port 489 and at the same time the second hydraulic port 490 is connected to a tank, the pressured oil is filled in the first open recess portion 480, and puts the valve plug 475 under stress from the inside, so that the flow-in port 471 is not opened even when warning pressure is applied from the flow-in port 471 side, for example.

On the other hand, if pressured oil is supplied to the second hydraulic port 490 and at the same time the first hydraulic port 489 is connected to the tank, the pressured oil is filled in the second open recess portion 481, and puts the pressure-receiving member 476 under stress from the inside, so that the flow-in port 471 is forcedly opened even when pressure is applied from the discharge port 472 side, for example.

In the case where the opening/closing valve 488 described above is used as the first and second opening/closing valves in the filter press type dewatering system 10 of FIG. 18, it operates in the perfectly same manner as the check valve 470 described above when no pressured oil is supplied to both the hydraulic ports (the first opening/closing valve 16 and the second opening/closing valve 18 of FIG. 18 will be hereunder read as a first opening/closing valve 488a and a second opening/closing valve 488b).

That is, when the piston 30 of the pressure-feed pump 12 is backward moved, the first opening/closing valve 488a is opened and the second opening/closing valve 488b is closed, so that slurry is filled in the cylinder 28. When the piston 30 is forwardly moved, the first opening/closing valve 488a is closed and the second opening/closing valve 488b is opened, so that the slurry is pressure-fed to the filter press machine 14 side.

At this time, the opening/closing operation of the valve plug 475 is automatically determined by the pressure applied to the valve plug 475 and the pressure-receiving member 476, and thus there is no risk that slurry flows back from the filter press machine 14 side due to erroneous opening/closing timing like the conventional electromagnetic opening/closing valve.

Furthermore, the spring 478 is not brought into contact with slurry, and thus no operation failure occurs like the ball type check valve 61.

When slurry is returned from the filter press machine 14, the control signal is output to the electromagnetic switching valve 493 to supply pressured oil to the second hydraulic port 490, and the first hydraulic port 489 is connected to the tank, whereby the first opening/closing valve 488a and the second opening/closing valve 488b are forcedly opened. Accordingly, it is unnecessary to newly equip the electromagnetic opening valve 25 for bypass and the feedback path 27.

### INDUSTRIAL APPLICABILITY

According to the first filter press type dewatering system and the control method according to the present invention, the dewatering pressure in the filter press machine can be adjusted in accordance with the flow amount of filtered water discharged from the filter press machine, and the progress degree of dewatering can be controlled.

Therefore, the applied pressure of the pressure-feed pump is suppressed so that the cake layer is not tightly solidified at the initial stage of the dewatering, and the relatively high dewatering efficiency is kept for a long time, so that the time needed to achieve a fixed dewatering amount can be shortened.

According to the second filter press type dewatering system and the dewatering method according to this invention, the cell membranes and the hydrophilic colloids can be heated/destroyed in advance by irradiating microwave, and the subsequent dewatering treatment can be effectively performed by the filter press machine.

By using the degasifier according to this invention, air contained in slurry can be effectively removed between the pressure-feed pump and the filter press machine, so that the pressure applying operation of the pressure-feed pump can be surely transmitted to slurry, and the slurry can be driven to the filter press machine under desired pressure.

According to the check valve of this invention, the spring for urging the valve plug in the closing direction is disposed in the valve plug accommodating portion which is liquid-tightly sealed through the valve plug, the pressure-receiving member and the seal member, and it is not brought into direct contact with the slurry. Therefore, there is no risk that operation failure occurs.

According to the opening/closing valve of this invention, it exhibits the same operation and effect as the check valve normally, and it is forcedly opened irrespective of the pressure applied to the valve plug and the pressure-receiving member by guiding pressured oil to the second hydraulic port with an electromagnetic switching valve or the like and at the same time connecting the first hydraulic port to the tank.

Therefore, there is an advantage that even when slurry clogging in the slurry introducing hole of each filter plate is returned from the filter press machine side to the slurry supply source side at the last stage of the dewatering treatment, it is necessary to equip neither an electrically opening/closing valve used exclusively to bypass nor a feedback path.

1. A filter press type dewatering system, comprising: a filter press machine; a hydraulically-driven pressure-feed pump for compressing slurry introduced from a slurry supply source and driving the slurry thus compressed into the filter press machine; a pressure control valve for increasing/reducing the flow rate of pressured oil supplied to the pressure-feed pump; a flow rate sensor for detecting the flow rate of filtered water discharged from the filter press machine; a pressure sensor for detecting dewatering pressure in the filter press machine; and control means for outputting a control signal to the pressure control valve in accordance with input signals from the flow rate sensor and the pressure sensor.

2. The filter press type dewatering system according to claim 1, wherein when the flow rate of filtered water per unit time which is detected by the flow rate sensor is larger than a predetermined flow rate, the flow rate of pressured oil supplied to the pressure-feed pump is reduced to lower the dewatering pressure in the filter press machine, and when the flow rate of filtered water per unit time which is detected by the flow rate sensor is lower than a predetermined flow rate, the flow rate of pressured oil supplied to the pressure-feed pump is increased to increase the dewatering pressure in the filter press machine, whereby the degree of progress of the dewatering in the filter press machine is adjusted.

3. A filter press type dewatering system comprising: a filter press machine; a pressure-feed pump for compressing slurry and driving the slurry thus compressed into the filter press machine; and a pre-treatment device disposed at a pre-stage of the pressure-feed pump, wherein the pre-treatment device has a slurry feed path for feeding the slurry from a slurry supply source side to the pressure-feed pump side, and a microwave oscillator for irradiating microwave to the slurry on the slurry feed path.

4. The filter press type dewatering system according to claim 3, wherein the pre-treatment device comprises a cylinder formed of microwave-transmissible material, a screw feeder disposed in the cylinder, a motor for rotating the screw feeder, an outer shell portion formed of microwave reflecting material which air-tightly covers the outer periphery of the cylinder, and a microwave oscillator disposed in the outer shell portion.

5. A slurry dewatering method comprising:
a step of irradiating microwave to slurry fed from a slurry supply source and heating/destroying cell membranes or hydrophilic colloids contained in the slurry;
a step of compressing the slurry and driving the slurry into a filter press machine; and
a step of executing solid-liquid separation of the slurry by filter fabric in the filter press machine.

6. A degasifier interposed between a pressure-feed pump and a filter press machine comprising:
an introducing port for taking slurry supplied from the pressure-feed pump;
a bore-enlarged portion that intercommunicates with the introducing port and is enlarged in bore from the pressure-feed pump side to the filter press machine side;
an air discharging portion intercommunicating with the bore-enlarged portion and having a discharged air guiding pipe;
a bore-reduced portion that intercommunicates with the air discharging portion and is reduced in bore from the pressure-feed pump side to the filter press machine side; and
a discharging port intercommunicated with the bore-reduced portion for feeding out the slurry to the filter press machine, wherein an exhaust pipe is connected to at least one end of the discharge air guiding pipe and a vent hole is formed in the surface at the bore-reduced portion side so that air flowing in the vent hole is discharged through the exhaust pipe to the outside.

7. The degasifier according to claim 6, wherein the air discharging portion is freely detachably interposed between the bore-enlarged portion and the bore-reduced portion.

8. The degasifier according to claim 6, wherein the air discharging portion comprises a first discharging unit and a second discharging unit each of which has a discharged air guiding pipe, the first and second discharging units being slidably equipped between the bore-enlarged portion and the bore-reduced portion so as to be exchangeable by each other.

9. The degasifier according to any one of claims 6 to 8, wherein porous ceramic filter or hollow fabric filter is mounted in the air discharging guide pipe of the air discharging portion.

10. The degasifier according to any one of claims 6 to 9, wherein the discharged air guiding pipe of the air discharging portion is formed so that the cross-section thereof is substantially wedge-shaped, and also is positioned so that the cusp thereof faces the pressure-feed pump side and the flat surface portion thereof faces the filter press machine side, the vent hole being formed in the flat surface portion.

11. The degasifier according to any one of claims 6 to 10, further comprising an opening/closing valve equipped in the air discharging pipe, a pressure sensor for detecting the pressure at the filter press machine side, and control means for closing the opening/closing valve when the pressure at the filter press machine side becomes a predetermined value or more.

12. A check valve comprising:
a case having a flow-in port and a discharge port;
a valve plug accommodating portion that is disposed in the case and has a first open portion confronting the flow-in port and a second open portion confronting the discharge port; a flow path through which the flow-in port and the discharge port intercommunicate with each other;
a cap-shaped valve plug that is freely slidably mounted in the first open portion and opens/closes the flow-in port;
a cap-shaped pressure receiving member that is freely slidably mounted in the second open portion;
a link portion for linking the valve plug and the pressure receiving member;
a spring that is disposed in the valve plug accommodating portion and urges the valve plug in the closing direction;
a first seal member that is interposed between the outer surface of the valve plug and the inner surface of the first open portion and prevents fluid from flowing into the valve plug accommodating portion; and
a second seal member that is interposed between the outer surface of the pressure receiving member and the inner surface of the second open portion and prevents fluid from flowing into the valve plug accommodating portion.

13. An opening/closing valve comprising: a case having a flow-in port and a discharge port; a valve plug accommodating portion that is disposed in the case and has a first open recess portion confronting the flow-in port, a second open recess portion confronting the discharge port, a partition portion through which both the open recess portions are partitioned, and a through hole formed in the partition portion; a flow path through which the flow-in port and the discharge port intercommunicate with each other; a cap-shaped valve plug that is freely slidably mounted in the first open recess portion and opens/closes the flow-in port; a cap-shaped pressure receiving member mounted in the second open recess portion so as to be freely slidable; a link portion having a front end portion connected to the valve plug and a rear end portion connected to the pressure receiving member under the state that the link portion is freely slidably inserted in the through hole; a spring that is disposed in the first open recess portion and urges the valve plug in the closing direction; a first seal member that is interposed between the outer surface of the valve plug and the inner surface of the first open recess portion and liquid-tightly seals the inside of the first open recess portion; a second seal member that is interposed between the outer surface of the pressure receiving member and the inner surface of the second open recess portion and liquid-tightly seals the inside of the second open recess portion; a third seal member that is interposed between the outer surface of the link member and the inner surface of the through hole and prevents fluid from flowing between the first open recess portion and the second open recess portion; a first hydraulic port intercommunicating with the first open recess portion; and a second hydraulic port intercommunicating with the second open recess portion.
